(19) United States
(12) Patent Application Publication
(10) Pub. No.: US 2012/0307926 A1
(43) Pub. Date: Dec. 6, 2012

(54) BEAM-FORMER SEARCHING METHOD AND CENTRAL UNIT USING THE METHOD

(75) Inventors: Ping-Heng Kuo, Pingtung County (TW); Pang-An Ting, Taichung City (TW)

(73) Assignee: INDUSTRIAL TECHNOLOGY RESEARCH INSTITUTE, Hsinchu (TW)

(21) Appl. No.: 13/149,938

(22) Filed: Jun. 1, 2011

(51) Int. Cl. H04B 7/02

(52) U.S. Cl. 375/267

(57) ABSTRACT

A beam-former searching method and a central unit using the method are proposed. The proposed method is adapted for a coordinated multi-point transmission for macro-diversity or an interference alignment scheme, and includes following steps. A metaheuristic algorithm is used to search for precoders and postcoders respectively for B of collaborative transmitters and U of receivers, where U=B for interference alignment and U=1 for coordinated multi-point transmission for macro-diversity. Memory is initialized by generating solution vectors randomly Utility functions is computed respectively for the generated solution vectors and the generated solution vectors are sorted respectively according to the computed utility functions. A new solution vector is improvised iteratively until the number of iterations reaches a pre-configured algorithm termination upper limit. In addition, a solution vector is selected as an output according to the computed utility functions.

### TECHNICAL FIELD

The disclosure generally relates to a beam-former searching method and a central unit using the same method in a wireless communication system.

### BACKGROUND

Most of the future cellular wireless broadband communication systems, such as Long Term Evolution Advanced (LTE-A) and next-generation WiMAX (IEEE 802.16m), are striving to provide access to high data rate applications in mobile environments. Although the users with strong links might be able to enjoy high speed services in these systems, cell-edge users are usually suffered from severe inter-cell interferences. Hence, several techniques have been proposed to alleviate the impacts of downlink interferences from neighboring cells. For example, multiple base stations (BS) could collaborate via backbone connections to mitigate the interference.

A few multi-BS downlink transmission techniques, such as closed-loop macro-diversity (CL-MD), have been included in the standard of IEEE 802.16m. In CL-MD, multiple BSs jointly transmit identical data to the mobile station (MS), so the performance could be improved due to RF combining gain. However, such gain might diminish when signals from different BSs are added destructively at the receiver. In correspondence, IEEE 802.16m has adopted a co-phasing mechanism, which allows the MS to provide information on desirable phase adjustments via feedback links. Since these phases are chosen from a quantized phase codebook, the MS requires to undertake a search to determine its feedback content. Alternatively, the search computation can also be conducted at the BS or a central controller connected to all collaboratively neighboring BSs.

However, if the precoders for all BSs are independently chosen, signals from multiple base stations might be out of phase and add up destructively at the MS. Also, the macro-diversity gain is thereby degraded when the number of collaborative base stations is large, the high computational complexity required by the co-phasing mechanism could be prohibited. The optimum selections can be identified with exhaustive search (ES) approach, but it may result in an unacceptable processing latency and computational complexity. The CL-MD scheme that is specifically considered in the present disclosure is illustrated in FIG. 1.

FIG. 1 is a schematic diagram illustrating a coordinated Multi-Point (CoMP) Macro-diversity downlink transmission. The system model and assumptions are presented below. A downlink transmission scenario is considered for the system model, in which a MS is located at the edge of the service coverage area of the serving BS. For example, referring to FIG. 1, a wireless system 10 includes a central unit 16 connecting to a serving BS 12, and neighboring BSs 11, 13. The block 121 connected to the serving BS 12 represents a signal of base precoder matrices Wₛ, intended to be transmitted to a MS 14.

In order to strengthen the signal, CL-MD mode is triggered. Hence, the MS is jointly served by M+1 collaborative BSs (including one serving BS 12 and M of neighboring BSs 11, 13). In CL-MD, the serving BS 12 shall first share the data with the other cells that are willing to cooperate through backbone connections, so all BSs involved in collaboration can concurrently send identical data (signal) to the MS 14. Therefore, the performance can be improved with the resultant macro-diversity gain.

It is also assumed that every BS has N>1 antennas and the MS 13 is equipped with single antenna, so the flat-fading channel of the MS with respect to each BS is a 1×N vector, denoted in FIG. 1 as hₛ and hᵢ for the serving BS 12 and the ith neighboring BSs 11, 13 (i=1, . . . , M), respectively. This the co-phasing mechanism adopted in the IEEE 802.16m standard.

Also, in the case of searching for precoders at the collaboratively neighboring base stations 11, 12, 13 as shown in FIG. 1, every base station is assumed to steer its signal by applying precoding techniques. For example, a block 111 connected to the neighboring BS 11 represents the transmitted signal W₁exp(j2 π b₁) from the neighboring BS 11, intended to be transmitted to a MS 14; a block 131 connected to the neighboring BS 13 represents the transmitted signal W₃exp(j2 π b₃) from the neighboring BS 13, intended to be transmitted to a MS 14, where b₁ and b₁ the are the phase rotations respectively for the neighboring BS 11 and the neighboring BS 13, with respect to the signal of base precoder matrices Wₛ.

In this case, the precoder for each base station is a N×1 vector chosen by the MS 14 from a phase codebook C, and the correspondent codeword indices are transmitted to the base stations 11, 12, 13 via the feedback mechanism. The precoders for the serving BS 12 and the neighboring BSs 11, 13 are denoted as Wₛ and Wᵢ respectively. It is also presumed that the precoder for any base station is selected based on mathematical equation (1).

$$W = arg {max}_{j ∈ C} {‖ hW ( j ) ‖}^{2} , b ∈ Φ \qquad equation ( 1 )$$

In the equation (1), the parameter W(j) represents the precoder with codeword index j. Ideally, the MS can acquire perfect knowledge on instantaneous channel state information (h) with pilots. Thus, the channel state information hₛ, h₁, h₂ shown in FIG. 1 are respectively corresponding to the neighboring BS 11, the serving BS 12 and the neighboring BS 13.

Apart from the base precoder indices, the MS could further determine and transmit back a concatenating precoder for each one of the neighboring BSs. A concatenating precoder is tantamount to a phase rotation operation on the readily chosen base precoder (or the base precoder matrices Wₛ). To be illustrated more specifically, the resultant precoder for the ith neighboring base stations, \tilde{W}ᵢ, is defined in equation (2).

\tilde{W}ᵢ=Wᵢexp(j2πbᵢ), i=1, . . . , M equation (2)

In the equation (2), bᵢ indicates the amount of phase rotation that should be carried out on Wᵢ, and such operation can be obviated for the serving BS 12. Also, bᵢ is selected from a phase codebook (denoted as Φ), which encompasses L of quantized elements between 0 and 1, and bᵢ can be expressed in equation (3).

$${b}_{i} ∈ Φ = \{ 0 , \frac{1}{L} , \frac{2}{L} , … , \frac{L - 1}{L} \} , i = 1 , … , M \qquad equation ( 3 )$$

The CL-MD scheme that is specifically considered in the present disclosure is illustrated in FIG. 1. The overall signal model for the CL-MD scheme shown in FIG. 1 can be expressed as equation (4).

y=H\tilde{W}x+n equation (4)

In the equation (4), channel state information matrix H can be expressed as equation (5) and precoder matrix W can be expressed as equation (6).

H=[hₛ h₁ h₂ . . . h_{M}] equation (5)

\tilde{W}=[Wₛ \tilde{W}₁ \tilde{W}₂ . . . \tilde{W}_{M}]^{T} equation (6)

In the equations (5) and (6), x, y and n represent transmitted signal, received signal and additive noise respectively. Thus, the signal gain can be expressed as equation (7).

ζ=∥H\tilde{W}∥² equation (7)

Clearly, the values of phase element b for each of the M neighboring cell (base stations) could have direct impacts on the resultant signal gain. Therefore, their values can be appropriately chosen to optimize transmission quality, i.e., to maximize the equation (7). The optimized phase element b can be expressed in mathematical equation (8).

$${b}^{opt} = arg {max}_{b ∈ ϕ} ‖ H [ \begin{matrix}{W}_{s} \\ {W}_{1} exp ( j2π {b}_{1} ) \\ ⋮ \\ {W}_{M} exp ( j2π {b}_{M} )\end{matrix} ] ‖ \qquad equation ( 8 )$$

In the equation (8), b^{opt} is a 1×M vector representing the set of b values that optimizes the equation (7). Conventional technique may use Exhaustive Search (ES, also known as brute-force search) approach to fulfill the requirements shown in the equation (8). However, the ES approach is probably prohibited in practice due to high complexity. Specifically, with the ES approach, all L^{M} of legitimate combinations are required to be inspected.

FIG. 2 is a schematic diagram illustrating a coordinated Multi-Point (CoMP) Macro-diversity downlink transmission with an interference alignment. The basic operation principle of the interference alignment (IA) is through proper precoding at the transmitters (and proper postcoding or shaping matrix at the receivers), all the received interference will be perfectly “aligned” in a subspace which is linear independent with the subspace of the useful messages. The idea of IA can be further understood in accordance with an example shown in FIG. 2.

Referring to FIG. 2, a wireless system 20 includes a central unit 16 connecting to collaboratively neighboring BSs (not shown in FIG. 2), and the blocks 21, 22, 23 shown in FIG. 2 represent the transmitted signals at the first BS, at the second BS and at the third BS, respectively. The wireless system 20 also includes a first MS, a second MS, and a third MS, where the first BS intends to transmit a first set of data to the first MS, the second BS intends to transmits a second set of data to the second MS, and the third BS intends to transmits a third set of data to the third MS in this example. The blocks 24, 25, 26 shown in FIG. 2 represent the received signals at the first MS, at the second MS and at the third MS, respectively. The blocks (labeled with H^{[11]}, H^{[21}], H^{[12]}, H^{[31]}, H^{[22]}, H^{[13]}, H^{[23]}, H^{[32]}, H^{[33]}) shown in the middle of FIG. 2 respectively refer to channel state information matrices between BSs and MSs.

For example, the H^{[11]} refers to the channel state information matrix between the first BS and the first MS; H^{[21}] refers to the channel state information matrix between the first BS and the second MS; H^{[32]} refers to the channel state information matrix between the second BS and the third MS. With IA technique, the base precoding matrices for the collaboratively neighboring BSs, precoding phase elements for the collaboratively neighboring BSs, and postcoding phase elements for the MSs may be determined beforehand and thus interference at the receivers may be perfectly “aligned” in a subspace which is linear independent with the subspace of the useful signals.

For example, in the block 24, one arrow labeled with H^{[11]}v₁^{[1]}x₁^{[1]} refers to the useful signal intended to be transmitted from the first BS to the first MS, while the received signals H^{[12]}v^{[2]}x^{[2]}, H^{[13]}v^{[3]}x^{[3]}, H^{[11]}v₂^{[1]}x₂^{[1]} in other two arrows in the block 24 respectively refer to the interference from the first BS, the second BS and the third BS. In the example of FIG. 2, the number of parameters required to be determined can be M=6 (three transmitters and three receivers), if the ES approach is used for determining beam-formers for all the transmitters and the receivers, all L^{M} of legitimate combinations are required to be inspected. This may probably be prohibited in practice due to high computation complexity. Therefore, it is a major concern to find a more efficient beam-former searching method for a coordinated multi-point transmission.

### SUMMARY

An exemplary embodiment of a beam-former searching method is introduced herein. According to an exemplary embodiment, the beam-former searching method is adapted for a coordinated multi-point transmission for macro-diversity, and includes following steps. A metaheuristic algorithm is used to search for precoders and postcoders respectively for B of collaborative transmitters and U of receivers, where U=1. The step of searching for the precoders and the postcoders respectively for the collaborative transmitters and the receiver includes: initializing memory by generating K solution vectors randomly; computing utility functions respectively for the generated solution vectors and sorting the generated solution vectors respectively according to the computed utility functions, where each one of the solution vector is consisted of M of phase elements selected from a pre-configured phase codebook, where M is the total number of entries of all involved beam-forming matrices; improvising a new solution vector for the generated solution vectors iteratively until the number of iterations, q, reaches a pre-configured algorithm termination upper limit, Q; and selecting a solution vector as an output according to the computed utility functions when the number of iterations, q, reaches the pre-configured algorithm termination upper limit, Q.

An exemplary embodiment of a beam-former searching method is introduced herein. According to an exemplary embodiment, the beam-former searching method is adapted for a coordinated multi-point transmission for an interference alignment scheme, and includes following steps. A metaheuristic algorithm is used to search for precoders and postcoders respectively for B of collaborative transmitters and U of receivers, where U=B. The step of searching for the precoders and the postcoders respectively for the collaborative transmitters and the receiver includes: initializing memory by generating K solution vectors randomly; computing utility functions respectively for the generated solution vectors and sorting the generated solution vectors respectively according to the computed utility functions, where each one of the solution vector is consisted of M of phase elements selected from a pre-configured phase codebook, where M is the total number of entries of all involved beam-forming matrices; improvising a new solution vector for the generated solution vectors iteratively until the number of iterations, q, reaches a pre-configured algorithm termination upper limit, Q; and selecting a solution vector as an output according to the computed utility functions when the number of iterations, q, reaches the pre-configured algorithm termination upper limit, Q.

An exemplary embodiment of a central unit is introduced herein. According to an exemplary embodiment, the central unit is adapted for searching beam-formers in coordinated multi-point transmission for macro-diversity, and includes a searching module. The searching module is configured for using a metaheuristic algorithm to search for precoders and postcoders respectively for B of collaborative transmitters and U of receivers, where U=1. The searching module includes a memory unit, a value generation unit, a determination unit, and a sorting unit. The memory unit is configured for temporarily storing a plurality of solution vectors. The value generation unit is coupled to the memory unit, and configured for initializing memory by generating K solution vectors randomly. The determination unit is coupled to the value generation unit, and configured for computing utility functions respectively for the generated solution vectors. The sorting unit is coupled to the memory unit and the determination unit, configured for sorting the generated solution vectors respectively according to the computed utility functions, where each one of the solution vector is consisted of M of phase elements selected from a pre-configured phase codebook, where M is the total number of entries of all involved beam-forming matrices. The value generation unit is also configured for improvising a new solution vector for the generated solution vectors iteratively until the determination unit determines that the number of iterations, q, reaches a pre-configured algorithm termination upper limit, Q. In addition, the determination unit is also configured for selecting a solution vector as an output according to the computed utility functions when the number of iterations, q, reaches the algorithm termination upper limit, Q.

An exemplary embodiment of a central unit is introduced herein. According to an exemplary embodiment, the central unit is adapted for searching beam-formers in coordinated multi-point transmission for an interference alignment scheme, and includes a searching module. The searching module is configured for using a metaheuristic algorithm to search for precoders and postcoders respectively for B of collaborative transmitters and U of receivers, where U=B. The searching module includes a memory unit, a value generation unit, a determination unit, and a sorting unit. The memory unit is configured for temporarily storing a plurality of solution vectors. The value generation unit is coupled to the memory unit, and configured for initializing memory by generating K solution vectors randomly. The determination unit is coupled to the value generation unit, and configured for computing utility functions respectively for the generated solution vectors. The sorting unit is coupled to the memory unit and the determination unit, configured for sorting the generated solution vectors respectively according to the computed utility functions, where each one of the solution vector is consisted of M of phase elements selected from a pre-configured phase codebook, where M is the total number of entries of all involved beam-forming matrices. The value generation unit is also configured for improvising a new solution vector for the generated solution vectors iteratively until the determination unit determines that the number of iterations, q, reaches a pre-configured algorithm termination upper limit, Q. In addition, the determination unit is also configured for selecting a solution vector as an output according to the computed utility functions when the number of iterations, q, reaches the algorithm termination upper limit, Q.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a coordinated Multi-Point (CoMP) Macro-diversity downlink transmission.

FIG. 2 is a schematic diagram illustrating a coordinated Multi-Point (CoMP) Macro-diversity downlink transmission with an interference alignment.

FIG. 3 is a functional block diagram of a central unit according to an exemplary embodiment.

FIG. 4A is a flowchart illustrating a beam-former searching method according to an exemplary embodiment.

FIG. 4B is a flowchart illustrating a beam-former searching method according to a first exemplary embodiment.

FIG. 5 is a flowchart illustrating a beam-former searching method according to a second exemplary embodiment.

FIG. 6 is schematic diagram illustrating a beam-former searching method according to a third exemplary embodiment.

FIG. 7 is schematic diagram illustrating simulation results of cumulative density functions of capacities with different co-phasing searching methods.

### DESCRIPTION OF THE EXEMPLARY EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

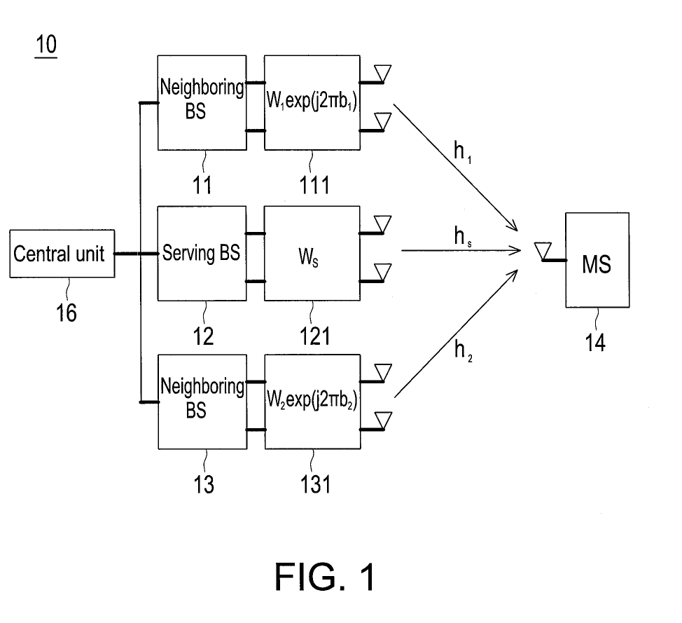

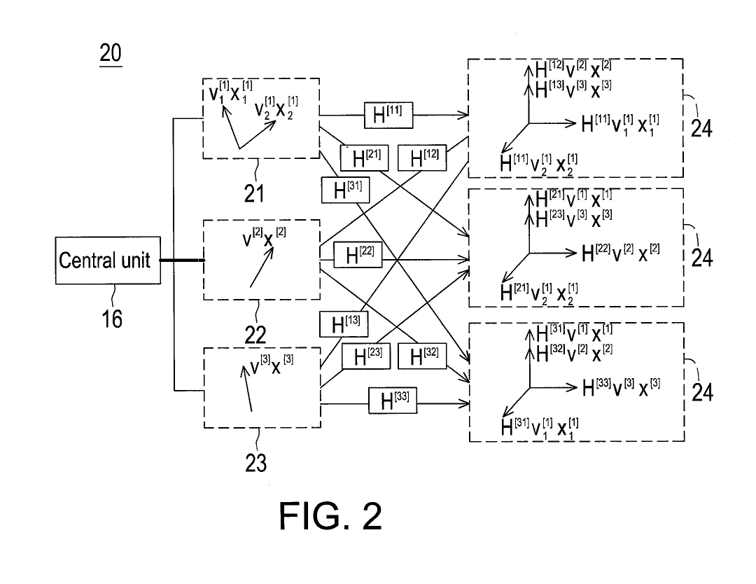

In the present disclosure, there is proposed a beam-former searching method and a central unit using the method. The central unit is similar to the ones shown in FIG. 1 and FIG. 2, and the proposed beam-former searching method can be implemented in the central unit for searching beam-formers in a coordinated multi-point transmission for macro-diversity or in a coordinated multi-point transmission for an interference alignment scheme. For example, the proposed beam-former searching method can be used to search phase elements for transmitters in the coordinated Multi-Point (CoMP) Macro-diversity downlink transmission as shown in FIG. 1.

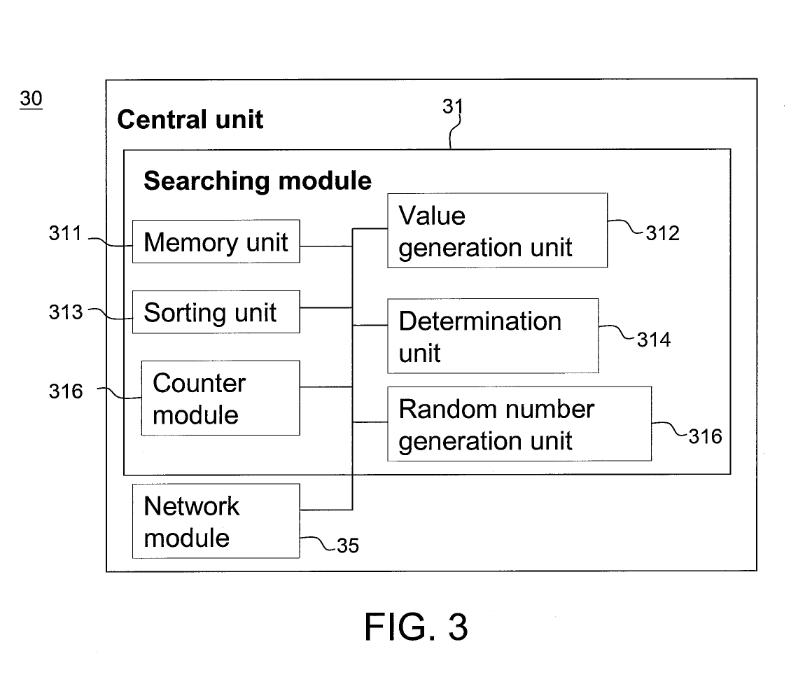

FIG. 3 is a functional block diagram of a central unit 30 according to an exemplary embodiment. The central unit 30 can be deployed in wireless communication systems implementing coordinated Multi-Point (CoMP) Macro-diversity downlink transmission such as those shown in FIG. 1 or deployed in coordinated multi-point transmission for an interference alignment scheme as shown in FIG. 2.

The central unit 30 could be adapted for searching beam-formers in Coordinated Multi-Point (CoMP) transmission for macro-diversity, and includes a searching module 31 and a network module 35. The network module 35 is connected with a plurality of transmitters and configured for transmitting and receiving data between the central unit 30 and the transmitters. Alternatively, the central unit 30 could also be used for searching beam-formers in coordinated multi-point (CoMP) transmission for the interference alignment scheme.

Referring to FIG. 3, the searching module 31 is configured for using a metaheuristic algorithm to search for precoders and postcoders respectively for B of collaboratively neighboring transmitters and U of receivers. For example, the searching module 31 can use the metaheuristic algorithm to search for F of base precoder matrices of the beam-formers respectively for the B of collaboratively neighboring transmitters, where F=(Nₜ+Nᵣ)×B, where Nₜ is the number of transmitting antenna of each transmitter, and Nᵣ is the number of receiving antenna of each receiver. Also, the searching module 31 can use the metaheuristic algorithm to search for G of co-phasing elements of the beam-formers respectively for the B collaboratively neighboring transmitters, where G=(Nₜ×Nᵣ). In addition, the searching module 31 can use the metaheuristic algorithm to search for G of postcoding elements of the beam-formers respectively for the U of receivers.

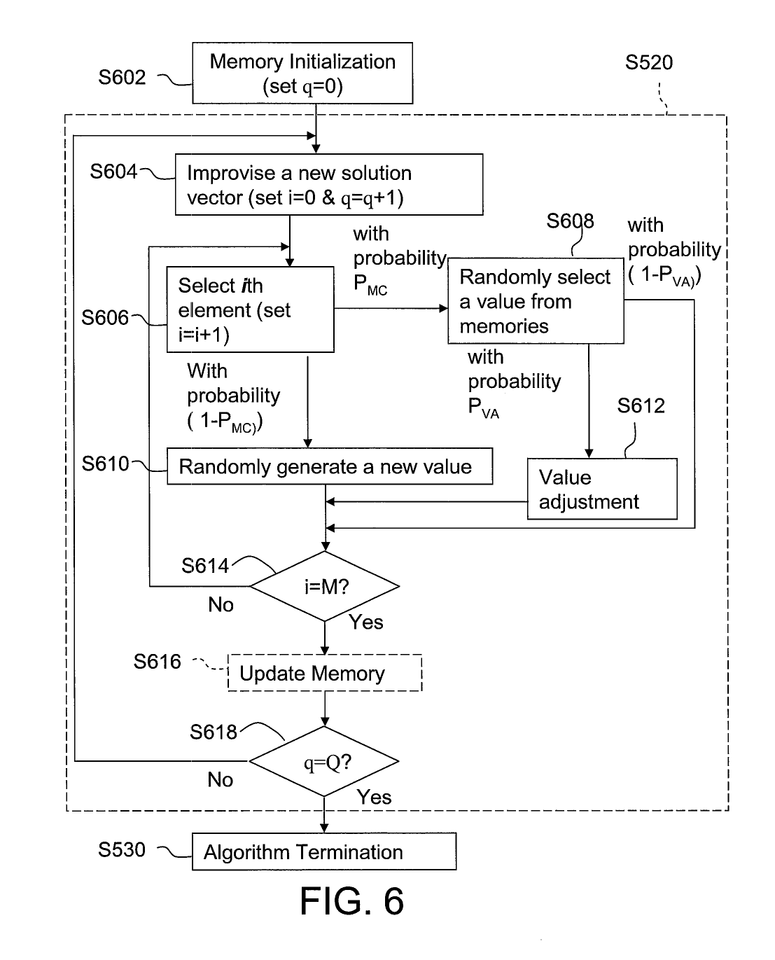

In the present disclosure, the metaheuristic algorithm could be, for example, a non-linear searching algorithm, a genetic searching algorithm, an ant-colony searching algorithm, a swarm-particle searching algorithm, a stochastic optimization algorithm, or a harmony searching algorithm, but the present disclosure is not limited thereto. The harmony searching algorithm will be described in details in accordance with FIG. 6.

The searching module 31 includes a memory unit 311, a value generation unit 312, a sorting unit 313, a determination unit 314, a random number generation unit 315, and counter module 316. The memory unit 311 is configured for temporarily storing a plurality of solution vectors. The value generation unit 312 is coupled to the memory unit 311, and configured for initializing memory to randomly generate K solution vectors. The determination unit 314 is coupled to the value generation unit 312, and configured for computing utility functions respectively for the generated solution vectors.

The sorting unit 313 is coupled to the memory unit 311 and the determination unit 314, and configured for sorting the generated solution vectors respectively according to the computed utility functions from the determination unit 314. Moreover, the random number generation unit 315 is coupled to the value generation unit 312 and the determination unit 314, and configured for generating random numbers between 0 and 1. The counter module 316 includes an iteration counter and an element counter.

In an exemplary embodiment, the searching module 31 can be deployed for an interference alignment (IA) technique such as the base stations and the mobile stations shown in FIG. 2. In this case, each one of the solution vector is consisted of M of elements selected from a pre-configured phase codebook, where M is the total number of entries of all involved beam-forming matrices. Also, the value generation unit 312 is configured for improvising a new solution vector for the generated solution vectors iteratively until the determination unit 314 determines that the number of iterations, q, reaches a pre-configured algorithm termination upper limit. Moreover, the determination unit 314 is configured for selecting a best solution vector as an output according to the computed utility functions when the determination unit 314 determines that the number of iterations, q, reaches the pre-configured algorithm termination upper limit, Q. For example, the M elements of each solution vector can be consisted of M₁ base precoder matrices, M₂ precoding phase elements for the B collaboratively neighboring transmitters, and M₃ postcoding phase elements for the U of receivers, where M=M₁+M₂+M₃.

However, in other embodiments, when the searching module 31 is deployed for searching beam-formers for a coordinated multi-point transmission for the interference alignment scheme, the metaheuristic algorithm is used to search for precoders and postcoders respectively for the B collaboratively neighboring transmitters, and U of collaboratively neighboring receivers, where U=B. In this case, the M phase elements of each solution vector is consisted of M₁ precoder weighting elements for the B transmitters, and M₂ postcoder weighting elements for the U receivers, where, M=M₁+M₂.

Moreover, when the searching module 31 is deployed for searching beam-formers for a coordinated multi-point transmission for macro-diversity, the metaheuristic algorithm is used to search for precoders and postcoders respectively for the B collaboratively neighboring transmitters, and U of collaboratively neighboring receivers, where U=1. In this case, each solution vector is consisted of M co-phasing elements for the B transmitters, where M=B.

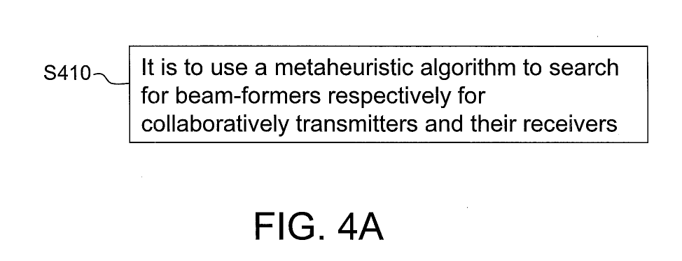

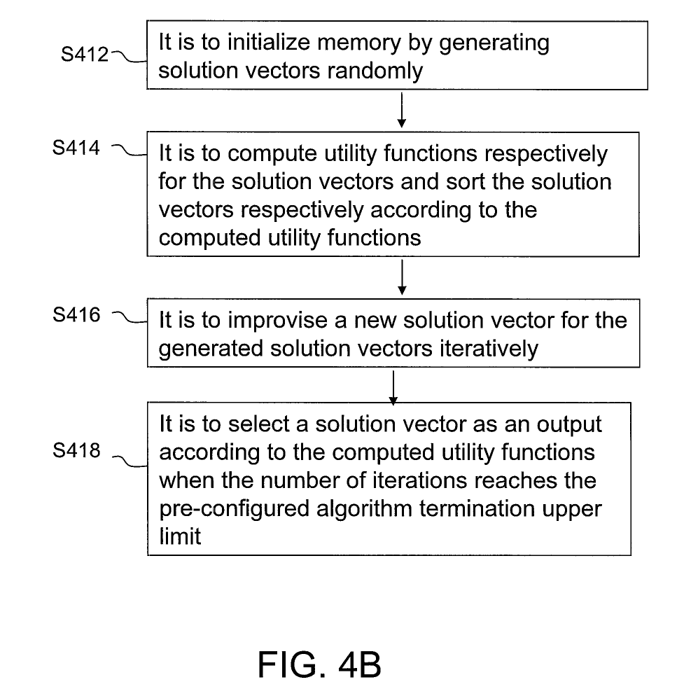

FIG. 4A is a flowchart illustrating a beam-former searching method according to a first exemplary embodiment. The proposed beam-former searching method includes following steps. In step S410, the searching module 31 uses a metaheuristic algorithm to search for beam-formers respectively for B of collaboratively neighboring transmitters and U of receivers. As mentioned previously, the metaheuristic algorithm can be, for example, a non-linear searching algorithm, a genetic searching algorithm, an ant-colony searching algorithm, a swarm-particle searching algorithm, a stochastic optimization algorithm, or a harmony searching algorithm. In the case of searching for precoders and postcoders respectively for a coordinated multi-point transmission for macro-diversity, the searching module 31 uses the metaheuristic algorithm to search for beam-formers respectively for B of collaboratively neighboring transmitters and U of receivers, where U=1. In the case of searching for precoders and postcoders respectively for a coordinated multi-point transmission for the interference alignment scheme, the searching module 31 uses a metaheuristic algorithm to search for beam-formers respectively for B of collaboratively neighboring transmitters and U of receivers, where U=B.

Also, the metaheuristic algorithm could also be used to search for F of base precoder matrices of the beam-formers respectively for the B of collaboratively neighboring transmitters, where F=(Nₜ+Nₜ)×B, where Nₜ is the number of transmitting antenna of each transmitter, and Nᵣ is the number of receiving antenna of each receiver.

Moreover, the metaheuristic algorithm could also be used to search for G of co-phasing elements of the beam-formers respectively for the B collaboratively neighboring transmitters, where G=(Nₜ×Nᵣ). Alternatively, the metaheuristic algorithm could also be used to search for beam-formers respectively for the collaboratively neighboring transmitters and the receivers further includes: using the metaheuristic algorithm to search for G of postcoding elements of the beam-formers respectively for the U receivers.

FIG. 4B is a flowchart illustrating a beam-former searching method according to a first exemplary embodiment. FIG. 4B provides a detailed illustration of FIG. 4A. In step S412, it is to initialize memory by generating K solution vectors randomly. In step S414, it is to compute the utility functions respectively for the generated solution vectors and sort the generated solution vectors respectively according to the computed utility functions, where each one of the solution vector is consisted of M of phase elements selected from a pre-configured phase codebook, where M is the total number of entries of all involved beam-forming matrices. In step S416, it is to improvise a new solution vector for the generated solution vectors iteratively until the number of iterations, q, reaches a pre-configured algorithm termination upper limit, Q. In step S418, it is to select a solution vector as an output according to the computed utility functions when the number of iterations, q, reaches the pre-configured algorithm termination upper limit, Q.

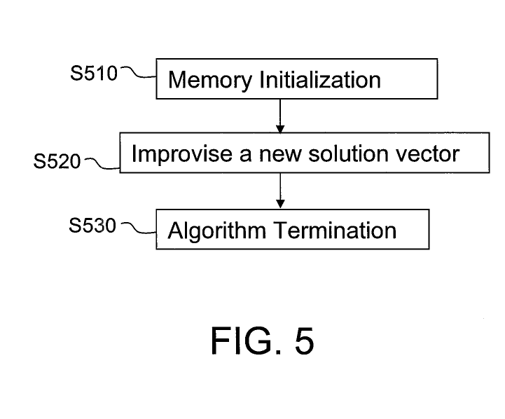

FIG. 5 is a flowchart illustrating a beam-former searching method according to a second exemplary embodiment. The second exemplary embodiment provides a detailed implementation of the first exemplary embodiment illustrated in FIG. 4B. Referring to FIG. 5, the proposed beam-former searching method is adapted for coordinated multi-point transmission, also adapted for a central unit as shown in FIG. 1 and FIG. 2, and includes following steps. In step S510, the value generation unit 312 performs a memory initialization.

In the memory initialization, the value generation unit 312 initializes the memory by generating K solution vectors randomly. Also, in the memory initialization, the determination unit 314 computes the utility functions respectively for the generated solution vectors. The utility functions respectively for the generated solution vectors can be, for example, signal gain, data rate, bit error rate, block error rate and so forth. In addition, in the memory initialization, the sorting unit 313 sorts the generated solution vectors respectively according to the computed utility functions, where each one of the solution vector is consisted of M of phase elements selected from a pre-configured phase codebook, where M is the total number of entries of all involved beam-forming matrices.

In step S520, the value generation unit 312 generates a new solution vector b^{New} in each iteration, where each entry in the new solution vector b^{New} is generated by randomly selecting a value from the initialized memory when a random number instantly generated between 0 and 1 by the random number generator unit 316 is less than or equal to a pre-configured memory consideration probability P_{MC}, or is generated by randomly selecting a value from a pre-configured codebook, where when the value is selected from the initialized memory, the selected value is further randomly adjusted by the value generation unit 312 to its neighbor values when a random number instantly generated between 0 and 1 by the random number generator unit 316 is less than or equal to a pre-configured value adjustment probability P_{VA}.

Also, in the step S520, the determination unit 314 updates the new solution vector b^{New} in the K solution vectors in each iteration when the sorting unit 311 determines that the new solution vector b^{New} supersedes at least one solution vector according to the computed utility functions. In each iteration, the sorting unit 311 determines that the new solution vector b^{New} supersedes the least favorable vector in the memory when the computed utility of the functions new solution vector b^{New} is more favorable than that of the least favorable solution vector in the existing memory. In addition, the sorting unit 311 sorts the updated K solution vectors according to the computed utility functions.

In step S530, the determination unit 314 determines whether the number of iterations reaches the pre-configured algorithm termination upper limit When the determination unit 314 determines that the number of iterations, q, reaches the pre-configured algorithm termination upper limit, Q, the determination unit 314 selects a best solution vector as an output according to the computed utility functions. The best solution vector is define as a solution vector whose computed utility function's value is better than (or more favorable than) those of the all other solution vector in the existing memory. For example, when the lower value of the utility function is considered better, and the utility function is bit error rate value, then the best solution vector can be the one with the bit error rate value lower than those of the all other solution vector in the existing memory. For another example, when the greater value of the utility function is considered better, and the utility function is signal gain, then the best solution vector can be the one with the signal gain greater than those of the all other solution vector in the existing memory. In an embodiment, the determination unit 314 selects a best solution vector with the computed utility function value superseding those for the rest solution vectors in the currently updated K solution vectors.

FIG. 6 is schematic diagram illustrating a beam-former searching method according to a third exemplary embodiment. FIG. 6 provides a more detailed illustration of FIG. 4B. The proposed beam-former searching method illustrated in FIG. 6 is initiated from step S602, where the memory initialization procedure is executed, and an iteration counter, q, is also initialized (the counter module 316 sets q=0). The detailed technical disclosure of the step S602 can be referred to the step S520 shown in FIG. 5.

In the present embodiment, steps S604-S618 together provides detailed technical disclosure of the step S520 shown in FIG. 5. In step S604, the value generation unit 312, the determination unit 314, the sorting unit 311, and the counter module altogether improvise a new solution vector in each one of the iterations. In particular, in the step S604, the counter module 316 initializes the element counter i=0, and increments the iteration counter q by 1 (the counter module 316 sets i=0 & q=q+1). In step S606, the value generation unit 312 selects the ith element (corresponding to the ith entry of the new solution vector b^{New} in each iteration) for improvisation, and the increments element counter i by 1 (the counter module 316 sets i=i+1).

In the present embodiment, after the step S606, step S608 is executed with a probability of a pre-configured memory consideration probability P_{MC}. The pre-configured memory consideration probability P_{MC} is, for example, 50%. On the other hand, after the step S606, step S610 is executed with a probability of (1−P_{MC}). In practice, the random number generation unit 315 can generate a memory consideration random number between 0 and 1 in the step S606, and the determination unit 314 further determines whether the generated memory consideration random number is greater than the pre-configured memory consideration probability P_{MC}. When the determination unit 314 further determines that the generated memory consideration random number is less than or equal to the pre-configured memory consideration probability P_{MC}, the step S610 is executed after the step S606; otherwise, when the generated memory consideration random number is greater than the pre-configured memory consideration probability P_{MC}, the step S608 is executed after the step S606.

In the step S608, the value generation unit 312 randomly selects a value from all entries of the current solution vectors for generating each entry in the new solution vector b^{New} for each one of the iterations.

In the present embodiment, after the step S608, step S612 is executed with a probability of a pre-configured value adjustment probability P_{VA}. The pre-configured value adjustment probability P_{VA} is, for example, 50%. On the other hand, after the step S608, step S614 is executed with a probability of (1−P_{VA}). In practice, the random number generation unit 315 can generate a value adjustment random number between 0 and 1 in the step S608, and the determination unit 314 further determines whether the generated value adjustment random number is less than or equal to the pre-configured value adjustment probability P_{VA}. When the determination unit 314 further determines that the generated value adjustment random number is less than or equal to the pre-configured value adjustment probability P_{VA}, the step S612 is executed after the step S608; otherwise, when the generated value adjustment random number is greater than the pre-configured value adjustment probability P_{VA}, the step S614 is executed after the step S608.

In the step S612, the value generation unit 312 further adjusts the currently generated entry, obtained in the step S608 for the new solution vector b^{New}. After the step S612, the step S614 is executed. In the step S610, the random number generation unit 315 generates a current entry in the new solution vector b^{New} by randomly generating a value. For example, in an embodiment, when the beam-former searching method is implemented just for searching precoding phase elements for the collaboratively neighboring base stations, the random number generation unit 315 can generate an index number within the range of index numbers shown in Table I below, and the determination unit 314 determines the randomly generated value from a pre-defined phase codebook corresponding to the index number. However, the present disclosure is not limited to the Table I, and in other embodiments, other phase codebook can also be used for the proposed beam-former searching method.

TABLE I

| index | b |
|---|---|
| 0 | 0 |
| 1 | 1/8 |
| 2 | 2/8 |
| 3 | 3/8 |
| 4 | 4/8 |
| 5 | 5/8 |
| 6 | 6/8 |
| 7 | 7/8 |

In the step S614, the determination unit 314 determines whether the element counter i reaches the size of the new solution vector b^{New}, M (the determination unit 314 determines the element counter i=M?). When the determination unit 314 determines that the element counter i does reach the size of the new solution vector b^{New}, after the step S614, the step S616 or step S618 is executed; otherwise, when the determination unit 314 determines that the element counter i reaches the size of the new solution vector b^{New}, after the step S614, the step S606 is returned. Also, in the step S614, the determination unit 314 computes the utility function for the new solution vector b^{New}.

In the step S616, the determination unit 314 updates the new solution vector b^{New} obtained in the current iteration when the new solution vector b^{New} supersedes one solution vector or more solution vectors according to the computed utility functions. Also, in the step S616, the sorting unit 313 sorts the updated k solution vectors. However, the step S616 is not always necessary, when the new solution vector b^{New} obtained in the current iteration does not supersedes any one of current k solution vectors, then the step S616 is not executed.

In the step S618, the determination unit 314 determines whether the iteration counter q reaches a re-configured algorithm termination upper limit, Q (the determination unit 314 determines the iteration counter q=Q?). The re-configured algorithm termination upper limit Q is, for example, 40 iterations. When the determination unit 314 determines that the iteration counter q reaches the re-configured algorithm termination upper limit Q, after the step S618, the step 530 is executed; otherwise, when the determination unit 314 determines that the iteration counter q does not reach the pre-configured algorithm termination upper limit Q, after the step S614, the step S604 is returned. The technical disclosure of the step S530 can be referred to FIG. 5

The proposed beam-former searching methods illustrated in FIG. 5-FIG. 6 can be deployed for coordinated multi-point transmission with interference alignment as shown in FIG. 2. However, the present disclosure can also be deployed in a non-interference alignment situation such as the case shown in FIG. 1. In such case, each one of the solution vectors is consisted of M precoding phase elements for the B collaboratively neighboring base stations, where M=B.

The proposed beam-former searching method (or a co-phasing mechanism of multi-cell joint transmission) is elaborated in details below. The equation (7) shown previously is employed as an example utility function. However, the present disclosure is not limited thereto, and the proposed beam-former searching method is also applicable with any other possible utility functions. There are several parameters defined below for the beam-former searching method, such as: K is memory size (or the size of each one of the solution vectors); Q is the total number of improvisation (or the pre-configured algorithm termination upper limit); P_{MC} is the memory consideration probability; t is consideration tendency of “good” memories (solution vectors);—P_{VA} is the value adjustment probability; Rₐ is allowable range for value adjustment. These parameters are explained in more details throughout the description of algorithmic procedures. In general, the algorithmic procedures of (the proposed beam-former searching method) can be segmented into three main parts, namely, memory initialization, improvisation, and algorithm termination. The overall flowchart of the algorithm procedures can be referred to FIG. 5 and FIG. 6.

The Part 1 is Memory Initialization, in which the value generation unit 312 firstly generates K solution vectors in a random manner. The solution vectors generated to imitate memory are termed as memory vectors (MV) in the following disclosure. The k^{th} (k=1, . . . , K) MV is formulated as equation (9).

b^{k}=[b^{k}₁, b^{k}₂, . . . , b^{k}_{M}], b ∈ Φ equation (9)

In the equation (9), the k^{th} MV has an associated objective function (or the utility function) which can be evaluated by substituting the entries of b^{k} into the equation (2) and then further into the equation (7) shown previously. These MVs are stacked together and then sorted in descending order in accordance to their objective function values. Hence, a memory matrix (MM) is constructed as equation (10).

$$MM = [ \begin{matrix}{b}^{1} \\ {b}^{2} \\ ⋮ \\ {b}^{K}\end{matrix} ] = [ \begin{matrix}{b}_{1}^{1} & {b}_{22}^{1} & … & {b}_{M}^{1} \\ {b}_{1}^{2} & {b}_{2}^{2} & … & {b}_{M}^{2} \\ ⋮ & ⋮ & ⋱ & ⋮ \\ {b}_{1}^{K} & {b}_{2}^{K} & … & {b}_{M}^{K}\end{matrix} ] , \\ with {ζ}_{1} > {ζ}_{2} > … > {ζ}_{k} \qquad equation ( 10 )$$

That is, a MV with better objective function has a smaller row index in MM.

The Part 2 is Improvisation, in which the algorithm (of the proposed beam-former searching method) can begin the improvisation process after completing the memory initialization. In general, the Part 2 of the algorithm is consisted of Q iterations, and each one of the iterations aims to generate a new solution vector, denoted as b^{New}. There are three possible ways to obtain each of the M elements (entries) of b^{New}: (1) select values from the memory vectors, (2) adjust the values chosen from the memory vectors, or (3) randomly generate new values. All these three possible ways of obtaining each entry of the new solution vector b^{New} can be referred to FIG. 6.

The choice of these three options can be governed by the probabilities that have been pre-configured. With a pre-configured memory consideration probability (0<P_{MC}<1), the value generation unit 312 would generate the ith element (entry) of the new solution vector b^{New} by choosing it from the memory vectors. This can be shown in equation (11).

bᵢ^{New}←bᵢ^{r} equation (11)

In the equation (11), the MV index, r, is given by equation (12).

r=ceil[U(0,1)^{t}×K] equation (12)

In the equation (12), the equation of U(0, 1) is a uniformly distributed random variable between 0 and 1, and the operator ceil[•] gives the nearest integer greater than the input argument. The parameter t≧1 controls the tendency of taking MVs with better objective functions. When t=1, the probabilities of considering all K MVs are identical (equal to 1/K). As the value of parameter t increases, MVs with better objective functions are more likely to be considered.

Once the determination unit 314 has determined to generate the new solution vector b^{New} by drawing from the memory vectors, the determination unit 314 can further decide whether the drawn element should be slightly adjusted to its neighbor values, based on the pre-configured value adjustment probability (0<P_{VA}<1). In other words, with a probability of P_{MC}×P_{VA} is obtained as following, the ith element (entry), bᵢ^{New}, of the new solution vector b^{New} can be obtained by following equation (13).

$${b}_{i}^{New} ← {b}_{i}^{r} + \frac{a}{L} , a ∈ {R}_{A} \qquad equation ( 13 )$$

In the equation (13), the MV index r is obtained from (12) and a is randomly selected within the adjustable range, R_{A}, defined as the following equation (14).

R_{A}={−Rₐ, −Rₐ+1, . . . , −1,1, . . . , Rₐ+1, Rₐ} equation (14)

Apparently, the maximum amount of allowable adjustment is limited by Rₐ, and the typical value of Rₐ is 1 or 2. Also, in the present disclosure, it does not matter if the adjusted values exceed the constrained range of Φ, as the phase rotation is circular symmetric.

If the algorithm (or the determination unit 314) has decided not to utilize the memory vectors in the first place, (which would occur with a probability of 1−P_{MC}), the bᵢ^{r} is simply generated by picking up an entry of Φ in a random manner. Also, the objective function of the new solution vector b^{New} is computed by the determination unit 314 straight after all M elements (entries) of the new solution vector b^{New} have been determined. If the objective function of the new solution vector b^{New} is better than the worst MV, it is inserted into MM by superseding the last row (b^{K}). Then, MM is again sorted by the sorting unit 313 based on the objective function (or the utility function) values, and the next iteration should start with the updated MM. Conversely, when the objective function (or the utility function) values of the new solution vector b^{New} is not better than any existing rows (solution vectors) of MM, it should be discarded and a new improvisation should be started without updating MM.

The Part 3 is Algorithm Termination, in which as the maximum number of improvisation, Q, has reached, the algorithm (or the determination unit 314) should terminate by taking the first row (i.e., the best MV) in the newest MM as the final solution vector. Moreover, in terms of search complexity, in addition to the evaluation of initial K of MVs, the algorithm (or the proposed beam-former searching method) has to compute the objective function of new solution vector b^{New} in each of the subsequent Q iterations. Thus, the proposed algorithm generally requires K+Q times of objective function calculations, which is much fewer than that of ES approach when the algorithmic parameters (in the proposed beam-former searching method) are pre-configured appropriately.

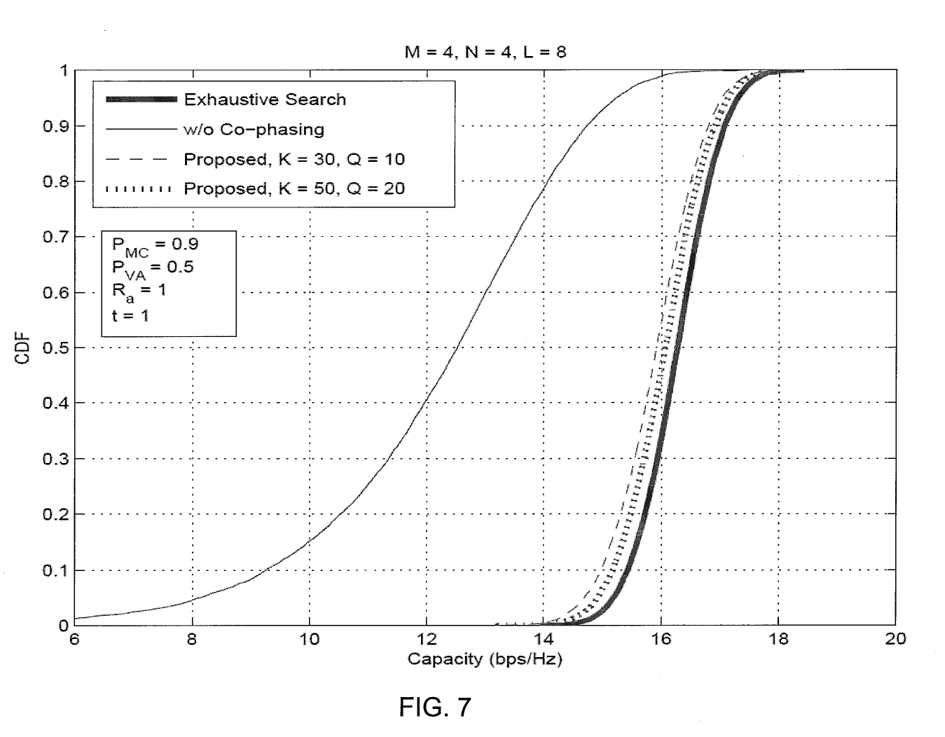

FIG. 7 is schematic diagram illustrating simulation results of cumulative density functions of capacities with different co-phasing searching methods. The simulation results are used to illustrate the computational efficiency of the algorithm (the proposed beam-former searching method). The horizontal axis in FIG. 7 is capacity measured in (bits per second per Hertz, or shown in bps/Hz), and the vertical axis is cumulative distribution function (CDF) of capacities.

A set of simulations has been launched to compare the performance of the proposed co-phasing searching method (beam-former searching method) with conventional exhaustive search (ES) approach. It is considered that the simulation is launched with a scenario with M=4 neighboring assistant base stations, each base station has Nₜ=4 antenna. The base precoders (Wₛ and Wᵢ) are chosen from the precoder codebook for cases with rank-1 and 4 of transmitters. Moreover, the phase codebook Φ has L=8 entries. In other words, the size of the phase codebook Φ is L=8. The channel coefficients are modeled as independent complex Gaussian random variables with zero-mean and unit variance (corresponding to Rayleigh fading). In order to illustrate the performance of the proposed method, observations are made on empirical cumulative distribution functions (CDFs) for the resultant capacity of closed-loop macro-diversity (CL-MD) transmission with different co-phasing schemes. In FIG. 10, the capacity, Γ, can be computed as following equation (15).

Γ=log₂(1+∥H\tilde{W}∥²)=log₂(1+ζ) equation (15)

It is also assumed in the simulations that both signal and noise power are unity. From the CDF curves plotted in FIG. 7, it can be seen that the performance of CL-MD is relatively poor without co-phasing. More remarkably, it is found that the achievable performance of the proposed algorithm (i.e., the proposed beam-former searching method illustrated in FIG. 6) is very close to that of ES approach (whose performance is seen as an upper bound for the simulation). In other words, the proposed beam-former searching method provides an alternative search method to determine the values of the solution vector b for multi-BS co-phasing operation (or the coordinated multi-point transmission), which is verified to be a simple, efficient and effective approach that can achieve sub-optimal performance.

In particular, the average capacity for the algorithm with (K, Q)=(50, 20) reaches 98.76% of that for ES. However, it is just required to calculate utility function (or objective function) for K+Q=70 times throughout the proposed algorithm, while ES approach requires L^{M}=4,096 times of inspection in total. The average capacity for the algorithm with (K, Q)=(30, 10) reaches 98.92% of that for ES. However, it is just required to calculate utility function (or objective function) for K+Q=40 times throughout the proposed algorithm.

In summary, according to the exemplary embodiments of the disclosure, a beam-former searching method and a central unit using the same method in a wireless communication system are proposed. A metaheuristic algorithm is used to search for beam-formers respectively for collaboratively neighboring transmitters and receivers, where the beam-formers may include base precoder matrices respectively for the collaboratively neighboring transmitters, co-phasing elements of the beam-formers respectively for the collaboratively neighboring transmitters, and postcoder elements respectively for the receivers. There is also proposed a detailed implementation of metaheuristic algorithm which includes randomly generate solution vectors in initialization phase, iteratively improvise new solution vector through randomly selecting entries from current solution vectors, stochastically adjust the selected entries values, or randomly generating entries for the new solution vectors. Accordingly, the computational time and complexity of determining beam-formers can be greatly reduced with similar performance to the exhaustive search approach.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A beam-former searching method, adapted for a coordinated multi-point transmission for macro-diversity, comprising:
using a metaheuristic algorithm to search for precoders and postcoders respectively for B of collaborative transmitters and U of receivers, wherein U=1, and the step of searching for the precoders and the postcoders respectively for the collaborative transmitters and the receiver comprises:
initializing memory by generating K solution vectors randomly;
computing utility functions respectively for the generated solution vectors and sorting the generated solution vectors respectively according to the computed utility functions, wherein each one of the solution vector is consisted of M of phase elements selected from a pre-configured phase codebook, wherein M is the total number of entries of all involved beam-forming matrices;
improvising a new solution vector for the generated solution vectors iteratively until the number of iterations, q, reaches a pre-configured algorithm termination upper limit, Q; and
selecting a solution vector as an output according to the computed utility functions when the number of iterations, q, reaches the pre-configured algorithm termination upper limit, Q.

2. The beam-former searching method according to claim 1, wherein the metaheuristic algorithm comprises a genetic search algorithm, an ant-colony search algorithm, a swarm-particle search algorithm, a harmony search algorithm, and a stochastic optimization algorithm.

3. The beam-former searching method according to claim 1, wherein the step of selecting a solution vector as the output according to the computed utility functions comprises selecting the solution vector with a more favorable utility function value than those of all the other solution vector in the existing memory.

4. The beam-former searching method according to claim 3, wherein each one of the solution vectors is consisted of M precoder co-phasing elements for the B collaborative transmitters, wherein M=B.

5. The beam-former searching method according to claim 4, further comprising:
generating a new solution vector b^{New} in each iteration, wherein each entry in the new solution vector b^{New} is generated by randomly selecting a value from the initialized memory when a random number instantly generated between 0 and 1 is less than or equal to a pre-configured memory consideration probability P_{MC}, or is generated by randomly selecting a value from a pre-configured codebook, wherein when the value is selected from the initialized memory, the selected value is further randomly adjusted to its neighbor values when a random number instantly generated between 0 and 1 is less than or equal to a pre-configured value adjustment probability P_{VA};
computing a utility function of the new solution vector b^{New}; and
superseding the least favorable solution vector in the memory by the new solution vector b^{New} in each iteration when the utility function of the new solution vector b^{New} is more favorable than the least favorable solution vector in the existing memory.

6. A beam-former searching method, adapted for a coordinated multi-point transmission for an interference alignment scheme, comprising:
using a metaheuristic algorithm to search for precoders and postcoders respectively for B of collaborative transmitters and U of receivers, wherein U=B, and the step of searching for the precoders and the postcoders respectively for the collaborative transmitters and the receiver comprises:
initializing memory by generating K solution vectors randomly;
computing utility functions respectively for the generated solution vectors and sort the generated solution vectors respectively according to the computed utility functions, wherein each one of the solution vector is consisted of M of phase elements selected from a pre-configured phase codebook, wherein M is the total number of entries of all involved beam-forming matrices;
improvising a new solution vector iteratively until the number of iterations, q, reaches a pre-configured algorithm termination upper limit, Q; and
when the number of iterations, q, reaches the pre-configured algorithm termination upper limit, Q, selecting a solution vector as an output according to the computed utility functions.

7. The beam-former searching method according to claim 6, the metaheuristic algorithm comprises a genetic search algorithm, an ant-colony search algorithm, a swarm-particle search algorithm, a harmony search algorithm, and a stochastic optimization algorithm.

8. The beam-former searching method according to claim 6, further comprising:
the step of selecting a solution vector as the output according to the computed utility functions comprises selecting the solution vector with a more favorable utility function value than those of all the other solution vector in the existing memory.

9. The beam-former searching method according to claim 6, wherein the M phase elements of each solution vector is consisted of M₁ precoder weighting elements for the B transmitters, and M₂ postcoder weighting elements for the U receivers, wherein, M=M₁+M₂.

10. A central unit, adapted for searching beam-formers in coordinated multi-point transmission for macro-diversity, the central unit comprising:
a searching module, configured for using a metaheuristic algorithm to search for precoders and postcoders respectively for B of collaborative transmitters and U of receivers, wherein U=1, wherein the searching module comprises:
a memory unit, configured for temporarily storing a plurality of solution vectors;
a value generation unit, coupled to the memory unit, configured for initializing memory by generating K solution vectors randomly;
a determination unit, coupled to the value generation unit, configured for computing utility functions respectively for the generated solution vectors;
a sorting unit, coupled to the memory unit and the determination unit, configured for sorting the generated solution vectors respectively according to the computed utility functions, wherein each one of the solution vector is consisted of M of phase elements selected from a pre-configured phase codebook, wherein M is the total number of entries of all involved beam-forming matrices;
the value generation unit is also configured for improvising a new solution vector for the generated solution vectors iteratively until the determination unit determines that the number of iterations, q, reaches a pre-configured algorithm termination upper limit, Q; and
the determination unit is also configured for selecting a solution vector as an output according to the computed utility functions when the number of iterations, q, reaches the algorithm termination upper limit, Q.

11. The central unit according to claim 10, wherein metaheuristic algorithm comprises a genetic search algorithm, an ant-colony search algorithm, a swarm-particle search algorithm, a harmony search algorithm, and a stochastic optimization algorithm.

12. The central unit according to claim 10, wherein the determination unit selects a solution vector, which has a more favorable utility function value than those of all the other solution vector in the existing memory, as the output.

13. The central unit according to claim 12, wherein each one of the solution vectors is consisted of M precoder co-phasing elements for the B collaborative transmitters, wherein M=B.

14. The central unit according to claim 13, further comprising:
a random number generator, configured for generating a random number between 0 and 1;
the value generation unit is also configured for generating a new solution vector b^{New} in each iteration, wherein each entry in the new solution vector b^{New} is generated by randomly selecting a value from the initialized memory when a random number between 0 and 1 instantly generated by a random number generator is less than or equal to a pre-configured memory consideration probability P_{MC}, or is generated by randomly selecting a value from a pre-configured codebook, wherein when the value is selected from the initialized memory, the selected value is further randomly adjusted to its neighbor values when a random number between 0 and 1 instantly generated by the random number generator is less than or equal to a pre-configured value adjustment probability P_{VA};
the a determination unit is also configured for computing a utility function of the new solution vector b^{New}; and
the sorting unit is also configured for superseding the least favorable solution vector in the memory by the new solution vector b^{New} in each iteration when the utility function of the new solution vector b^{New} is more favorable than the least favorable solution vector in the existing memory.

15. A central unit, adapted for searching beam-formers in coordinated multi-point transmission for an interference scheme, the central unit comprises:
a searching module, configured for using a metaheuristic algorithm to search for precoders and postcoders respectively for B of collaborative transmitters and U of receivers, wherein U=B, wherein the searching module comprises:
a memory unit, configured for temporarily storing a plurality of solution vectors;
a value generation unit, coupled to the memory unit, configured for initializing memory by generating K solution vectors randomly;
a determination unit, coupled to the value generation unit, configured for computing utility functions respectively for the generated solution vectors;
a sorting unit, coupled to the memory unit and the determination unit, configured for sorting the generated solution vectors respectively according to the computed utility functions, wherein each one of the solution vector is consisted of M of phase elements selected from a pre-configured phase codebook, wherein M is the total number of entries of all involved beam-forming matrices;
the value generation unit is also configured for improvising a new solution vector for the generated solution vectors iteratively until the determination unit determines that the number of iterations, q, reaches a pre-configured algorithm termination upper limit, Q; and
the determination unit is also configured for selecting a solution vector as an output according to the computed utility functions when the number of iterations, q, reaches the algorithm termination upper limit, Q.

16. The central unit according to claim 15, wherein metaheuristic algorithm comprises a genetic search algorithm, an ant-colony search algorithm, a swarm-particle search algorithm, a harmony search algorithm, and a stochastic optimization algorithm.

17. The central unit according to claim 15, wherein the determination unit selects a solution vector, which has a more favorable utility function value than those of all the other solution vector in the existing memory, as the output.

18. The central unit according to claim 15, wherein the M phase elements of each solution vector is consisted of M₁ precoder weighting elements for the B transmitters, and M₂ postcoder weighting elements for the U receivers, wherein, M=M₁+M₂.
